(19) United States
(12) Patent Application Publication
(10) Pub. No.: US 2021/0152359 A1
(43) Pub. Date: May 20, 2021

(54) AUTHENTICATION DEVICE BASED ON BIOMETRIC INFORMATION, CONTROL SERVER AND APPLICATION SERVER, AND OPERATION METHOD THEREOF

(71) Applicant: KT Corporation, Seongnam-si, Gyeonggi-do (KR)

(72) Inventors: Tae-Gyun KIM, Seongnam-si (KR); Daesung CHO, Seoul (KR); Myung Woo KIM, Guri-si (KR); Deok-Moon CHANG, Seoul (KR)

(73) Assignee: KT Corporation, Seongnam-si, Gyeonggi-do (KR)

(21) Appl. No.: 16/065,361

(22) PCT Filed: Dec. 22, 2016
(86) PCT No.: PCT/KR2016/015074

§ 371 Date: Nov. 15, 2018

(30) Foreign Application Priority Data
Dec. 23, 2015 (KR) 10-2015-0185448
Dec. 20, 2016 (KR) 10-2016-0175017

(51) Int. Cl. H04L 9/32; H04L 9/14; H04L 9/08

(52) U.S. Cl. CPC H04L 9/3231; H04L 9/0819; H04L 9/0869; H04L 9/14

(57) ABSTRACT

A method of uploading and downloading data to an application server requested from a computing device, by a biometric information based authentication device which is connected to the computing device and interworks with a control server, is provided. The method includes detecting an upload request message which is transmitted from the computing device to the application server, extracting a first identifier included in the upload request message, outputting a first biometric information authentication result for input first biometric information, and transmitting upload authentication information comprising the first identifier, the first biometric information authentication result, and a first data encryption key to the control server.

### TECHNICAL FIELD

The present invention relates to biometric information-based authentication.

### BACKGROUND ART

A cloud storage service which stores data in a remote server and accesses a server through a network to browse and download data is being widely used.

Most cloud storage services set a specified login method to verify an access right of a user and request the user to login. According to login methods so far, generally, an ID and a password which are registered at the time when the user joins the cloud storage service are used.

Further, most cloud storage services store data as plain text. Therefore, when the ID and the password are exposed through hacking, data stored in the cloud storage services may be leaked. As described above, if someone finds out the ID and password, someone can easily access the stored data. As described above, the cloud storage services have an advantage of improving data accessibility, but cannot ensure the security so that there is a restriction in that data which requires business security or privacy protection cannot be stored in the remote storage.

### DISCLOSURE

### Technical Problem

The present disclosure has been made in an effort to provide a biometric information based authentication device, a control server interworking with the same, and an application server, and an operating method thereof.

### Technical Solution

An exemplary embodiment provides a method of processing login to an application server requested from a computing device, by a biometric information based authentication device which is connected to the computing device and interworks with a control server. The method includes detecting a login request message which is transmitted from the computing device to the application server, extracting an identifier included in the login request message, outputting a biometric information authentication result for input biometric information, and transmitting login authentication information comprising the identifier and the biometric information authentication result to the control server. The identifier is transmitted from the control server to the application server to determine, by the application server, a login permitted target. The biometric information authentication result is to determine, by the control server, whether the login to the application server is permitted.

The login authentication information may further include user identification information. The user identification information may be to determine whether the user is a registered user by at least one of the control server and the application server.

The identifier may be randomly generated by the computing device.

Another exemplary embodiment provides a method of uploading and downloading data to an application server requested from a computing device, by a biometric information based authentication device which is connected to the computing device and interworks with a control server. The method includes detecting an upload request message which is transmitted from the computing device to the application server, extracting a first identifier included in the upload request message, outputting a first biometric information authentication result for first biometric information received, and transmitting upload authentication information comprising the first identifier, the first biometric information authentication result, and a first data encryption key to the control server. The first identifier is transmitted from the control server to the application server to determine, by the application server, an upload permitted target. The first biometric information authentication result determines, by the control server, whether the upload is permitted. The first data encryption key is transmitted from the control server to the application server to encrypt, by the application server, the requested data of the upload.

The upload authentication information may further include user identification information. The user identification information may be to determine whether the user is a registered user by at least one of the control server and the application server.

The data upload and download method may further include fetching the first data encryption key when the first biometric information authentication result is successful.

The data upload and download method may further include detecting a download request message which is transmitted from the computing device to the application server, extracting a second identifier included in the download request message, outputting a second biometric information authentication result for second biometric information received, transmitting download authentication information comprising the second identifier, the second biometric information authentication result, and a second data encryption key to the control server, receiving download data related to the download request message from the application server, and transmitting the download data to the computing device. The second identifier may be transmitted from the control server to the application server to determine a download permitted target in the application server. The second biometric information authentication result may be used to determine, by the control server, whether the download is permitted. The second data encryption key may be transmitted from the control server to the application server to decode, by the application server, the download requested data.

The data upload and download method may further include detecting a download request message which is transmitted from the computing device to the application server, extracting a second identifier included in the download request message, outputting a second biometric information authentication result for second biometric information received, transmitting download authentication information comprising the second identifier and the second biometric information authentication result to the control server, receiving download data related to the download request message from the application server, and decoding the download data with a second data encryption key related to the first data encryption key to transmit the decoded download data to the computing device. The second identifier may be transmitted from the control server to the application server to determine, by the application server, a download permitted target. The second biometric information authentication result may be to determine, by the control server, whether the download is permitted.

Yet another exemplary embodiment provides a method of processing a procedure requested from a computing device, by a control server which interworks with a biometric information based authentication device and an application server. The method includes receiving upload authentication information comprising a first identifier, a first biometric information authentication result, and a first data encryption key from the authentication device, determining the first identifier as an upload permitted target based on the upload authentication information, and transmitting an upload permission request message comprising the first identifier and the first data encryption key to the application server. The first identifier may be to determine, by the application server, an upload permitted target. The first data encryption key may be to encrypt, by the application server, upload requested data.

The processing method may further include receiving, from the authentication device, download authentication information comprising a second identifier and a second biometric information authentication result, determining the second identifier as a download permitted target based on the download authentication information, and transmitting a download permission request message comprising the second identifier to the application server. The second identifier may be to determine, by the application server, a download permitted target.

The first identifier may be determined as the upload permitted target, when the upload authentication information further comprises user identification information, the user identification information is registered information and the first biometric information authentication result is successful. The second identifier may be determined as the download permitted target, when the download authentication information further comprises the user identification information, the user identification information is registered information and the second biometric information authentication result is successful.

Yet another exemplary embodiment provides a method of processing a procedure requested from a computing device, by an application server which interworks with a control server. The method includes receiving an upload permission request message comprising a first identifier and a first data encryption key from the control server, receiving an upload request message comprising a first identifier and upload requested data from the computing device, and encrypting and storing the upload requested data using the first data encryption key corresponding to the first identifier. The first data encryption key is generated in a biometric information based authentication device and is transmitted to the control server from the authentication device.

The upload permission request message may further include user identification information. The encrypting and storing the upload requested data may include, when the user identification information is registered information, encrypting the upload requested data and storing the encrypted data in a storage corresponding to the user identification information.

The processing method may further include receiving a download permission request message comprising a second identifier and a second data encryption key from the control server, receiving a download request message comprising the second identifier and a download request for specific data from the computing device, decoding the specific data using the second data encryption key corresponding to the second identifier, and transmitting the decoded data to the computing device. The second data encryption key may be generated by the authentication device and be transmitted to the control server from the authentication device.

The encrypting and storing the upload requested data may include, when the upload permission request message further comprises user identification information and the user identification information is registered information, encrypting the upload requested data and storing the encrypted data in a storage corresponding to the user identification information. The decoding the specific data may include, when the download permission request message further comprises the user identification information and the user identification information is registered information, locating the specific data from the storage corresponding to the user identification information and decoding the specific data with the second data encryption key.

The processing may further include receiving a download permission request message including a second identifier from the control server, receiving a download request message comprising a second identifier and a download request for specific data from the computing device, and transmitting the specific data corresponding to the second identifier to the authentication device. The specific data may be decoded by the authentication device.

Yet another exemplary embodiment provides a biometric information based authentication device. The authentication device includes at least one sensor which recognizes biometric information, at least one communication interface which communicates with a plurality of external devices, a memory which stores a program, a security module which encrypts input data and output the encrypted data, and a processor which interworks with the sensor, the communication interface, the memory, and the security module to execute a plurality of operations of the program. The program includes a first program for data upload authentication. The first program may include instructions for activating the sensor when an upload request message transmitted from a computing device to an application server is detected, generating upload authentication information after obtaining a first data encryption key from the security module, and transmitting the upload authentication information to a control server. The upload authentication information may include a first identifier extracted from the upload request message, a first biometric information authentication result of first biometric information input from the sensor, and the first data encryption key. The first identifier may be transmitted from the control server to the application server to determine, by the application server, an upload permitted target. The first biometric information authentication result may be to determine, by the control server, whether the upload is permitted. The first data encryption key may be transmitted from the control server to the application server to encrypt, by the application server, upload requested data.

The program may include a second program for data download authentication. The second program may include instructions for activating the sensor when a download request message transmitted from the computing device to the application server is detected, generating download authentication information after obtaining a second data encryption key from the security module, and transmitting the download authentication information to the control server. The download authentication information may include a second identifier extracted from the download request message and a second biometric information authentication result of second biometric information input from the sensor. The second identifier may be transmitted from the control server to the application server to determine, by the application server, a download permitted target. The second biometric information authentication result may be to determine, by the control server, whether the download is permitted.

The second program may further include instructions for decoding the download data with a second data encryption key related to the first data encryption key, and transmitting the download data to the computing device, in response to receiving the download data related to the download request message from the application server.

The program may include a third program for login authentication. The third program may include instructions for activating the sensor when a login request message transmitted from the computing device to the application server is detected, generating login authentication information, and transmitting the login authentication information to the control server. The login authentication information may include a third identifier extracted from the login request message and a third biometric information authentication result of third biometric information input from the sensor. The third identifier may be transmitted from the control server to the application server to determine a login permitted target in the application server. The third biometric information authentication result may be used to determine, by the control server, whether the login is permitted.

### Advantageous Effects

According to an exemplary embodiment, an application server encrypts and stores the data so that even though the encrypted data may be exposed, the encrypted data cannot be decoded by the other party. According to an exemplary embodiment, the application server encrypts and decodes the data using an encryption key which temporarily exists when the data is uploaded/downloaded, so that the encryption key is not stored in any of network devices. Therefore, according to an exemplary embodiment of the present invention, security can be enhanced. Further, according to the exemplary embodiment, since a communication line (channel or session) between the authentication device and the application server is encrypted, data transmitted between the authentication device and the application server is encrypted by communication channel encryption technology and the encryption key to be protected. Therefore, the security of the data in all or some of the transmission sections and storage locations is very high.

### DESCRIPTION OF THE DRAWINGS

FIG. 1 is a block diagram illustrating an authentication device, according to an exemplary embodiment.

FIG. 2 is a block diagram illustrating a system in which an authentication device is connected to other devices, according to an exemplary embodiment.

FIG. 3 is a block diagram illustrating hardware configuration of an authentication device, according to an exemplary embodiment.

FIG. 4 is a flow diagram illustrating an authentication information registering method of an authentication device, according to an exemplary embodiment.

FIG. 5 is a flow diagram illustrating a login method, according to an exemplary embodiment.

FIG. 6 is a flow diagram illustrating a data uploading method, according to an exemplary embodiment.

FIG. 7 is a flow diagram illustrating a data downloading method, according to an exemplary embodiment.

FIG. 8 is a flow diagram illustrating a data downloading method according to another exemplary embodiment.

### MODE FOR INVENTION

In the following detailed description, only certain exemplary embodiments have been shown and described, simply by way of an illustration. As those skilled in the art would realize, the described exemplary embodiments may be modified in various different ways, all without departing from the spirit or scope of the present disclosure. Accordingly, the drawings and description are to be regarded as illustrative in nature and not restrictive. Same reference numerals designate like elements throughout the present disclosure.

In the present disclosure, unless explicitly described to the contrary, the word “comprise” and variations such as “comprises” or “comprising”, will be understood to imply the inclusion of stated elements but not the exclusion of any other elements. In addition, the terms “-er”, “-or” and “module” described in the specification mean units for processing at least one function and operation and can be implemented by hardware components or software components and combinations thereof.

Biometric information used for authentication may be various different types, such as a fingerprint, an iris, a vein, and so on. Hereinafter, for description, a fingerprint is used as an example, but the biometric information used in the present disclosure is not limited to the fingerprint. Further, according to an exemplary embodiment, a plurality of biometric information can be combined and used for the authentication.

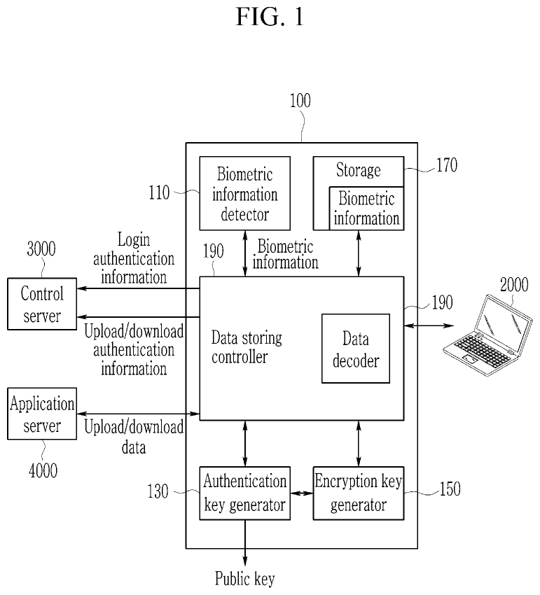

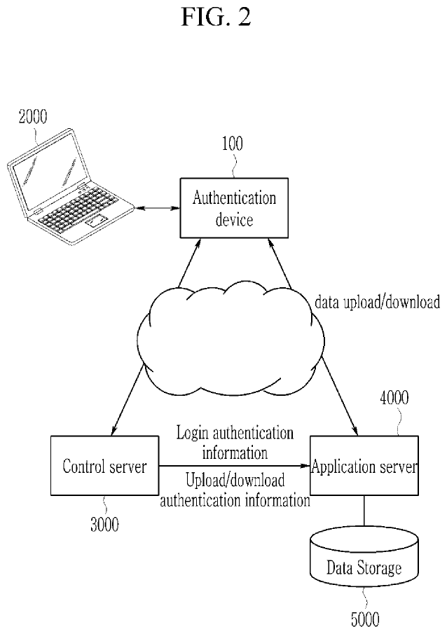

FIG. 1 is a block diagram illustrating an authentication device, according to an exemplary embodiment and FIG. 2 is a block diagram illustrating a system in which an authentication device is connected to other devices, according to an exemplary embodiment.

Referring to FIGS. 1 and 2, the authentication device 100 is a hardware security device including a processor (CPU) and an operating system (OS). When the authentication device 100 is connected to a computing device 2000, the authentication device is booted with supplied electricity and operates as an independent system from the computing device 2000. Further, when the authentication device 100 is connected to the computing device 2000, the authentication device 100 may disable some functions of the computing device 2000 and enable only internal functions of the authentication device 100.

Referring to FIG. 2, the network includes a control server 3000, an application server 4000, and a data storage 5000. Here, the data storage 5000 is at least one data storage which interworks with the application server 4000 to store data by a storing request (upload request) of the application server 4000 and transmit the stored data to the application server 4000 by an output request (download request).

The authentication device 100 may be connected to the computing device 2000 through a communication interface (not illustrated). The communication interface may be selected from various wired/wireless interfaces. For example, the communication interface may be a USB interface and may also be other communication interfaces which may be connected to the computing device 2000. Further, the authentication device 100 may include a plurality of communication interfaces.

Furthermore, the authentication device 100 may further include a communication interface (not illustrated) which can be directly connected to a communication network, that is, a communication module and may be connected to various network devices through the communication module. The communication module may be selected from various communication modules which may be connected to a wired/wireless network. For example, the communication module may be a wireless communication module which can be wirelessly connected to an access point such as Bluetooth or WiFi or a wired communication module which can be connected to a communication network through a wired cable.

In the meantime, when the authentication device 100 is connected to the computing device 2000, the communication module for Internet connection of the computing device 2000 becomes disabled and it is implemented to be connected to the external communication network only by the communication module of the authentication device 100. Hereinafter, it will be described that when the authentication device 100 is connected to the computing device 2000, the communication module for Internet connection of the computing device 2000 is disabled and the authentication device is connected to the external communication network only by the communication module of the authentication device 100. Packets output from the computing device 2000 or packets input to the computing device 2000 are transmitted via the authentication device 100. Therefore, the authentication device 100 detects the packets output from the computing device 2000 or the packets input to the computing device 2000 and checks contents (messages) of the packets.

Referring back to FIG. 1, the authentication device 100 includes a biometric information detector 110, an authentication key generator 130, an encryption key generator 150, a storage 170, and a data storing controller 190.

The biometric information detector 110 is a sensor which detects, recognizes, or senses the biometric information of a user. The biometric information detector 110 is automatically activated when the authentication device 100 is supplied with electricity to be booted or the biometric information detector 110 may be activated by receiving a control signal from a controller (processor) of the authentication device 100. The biometric information detector 110 has unique sensor identification information (sensor_id). Serial information of the sensor may be used as the sensor identification information, but is not limited thereto. Hereinafter, a fingerprint will be described as an example of the biometric information. The biometric information detector 110 stores sensed fingerprint information in the storage 170.

The authentication key generator 130 registers (stores) fingerprint information and generates a public key and a private key during an authentication information registering operation. The authentication key generator 130 transmits the public key to the control server 3000. The private key is stored in a designated location. In an exemplary embodiment, the private key is encrypted to be stored. The private key may be encrypted by a hardware security module (HSM).

The authentication key generator 130 generates the public key and the private key according to a key generating algorithm. The key generating algorithm may be an RSA key generating algorithm. Information which is received by the authentication key generator 130 at the time of generating the public key and the private key may be designed in various forms. For example, the authentication key generator 130 receives random numbers and generates the public key and the private key based on the random numbers. The authentication key generator 130 may generate the public key and the private key based on the biometric (fingerprint) information. Alternatively, the authentication key generator 130 may generate the public key and the private key based on the biometric information and additional identification information. There may be various additional identification information. The additional identification information may be identification information (for example, a serial number) of the authentication device 100 or device related identification information such as identification information of specific hardware included in the authentication device 100. For example, the identification information of the specific hardware may be sensor identification information (sensor_id) of the biometric information detector 110. The additional identification information may be user-related identification information such as a user password, a resident registration number (Social Security number), and the like. Further, the additional identification information may be a combination of the device-related identification information and the user-related identification information.

The encryption key generator 150 generates a data encryption key used for data encryption. The data encryption key may be generated at the time of registering authentication information. Information input when the encryption key generator 150 generates a data encryption key may be designed in various forms. For example, the encryption key generator 150 may generate the data encryption key based on at least one of the biometric information and the additional identification information. The encryption key generator 150 may receive biometric information and generate the data encryption key based on the biometric information, but is not limited thereto. Further, the data encryption key may be stored in the authentication device 100 or may not be stored in the authentication device 100 but may be generated based on the biometric information input by the user whenever data encryption/decoding is required. The stored data encryption key may be called by inputting the fingerprint. The data encryption key may be encrypted with fingerprint information, the password, or the private key to be stored. The encryption key generator 150 may be a hardware security module (HSM). The encryption key generator 150 may generate a data encryption key using an advanced encryption standard (AES) encryption algorithm.

The data storing controller 190 may receive a list (white list) of fingerprint login sites which support the biometric information based login from the control server 3000. Here, it is assumed that the data storing controller 190 knows that the application server 4000 is a fingerprint login site and stores various information (for example, a host name (Host), an IP address, and URL) which may identify the application server 4000.

When the user accesses the application server 4000 through the computing device 2000 or requests the login after accessing the application server 4000, a login request message is transmitted from the computing device 2000 to the application server 4000.

The login request message includes an identifier (ID) indicating a target of authentication and the identifier may be randomly generated in the computing device 2000. While the identifier is valid, the authentication device 100, the control server 3000, and the application server 4000 check the identifier included in the received message to commonly identify the target of authentication. Since the identifier is generated in the computing device 2000, the identifier may be information indicating that the message is transmitted from the computing device 2000. The login request message may further include user identification information. The user identification information may be various information for identifying the user, such as identification information (serial information) of the authentication device, user's ID and password, or a phone number. The computing device 2000 may receive the user identification information from the user. Alternatively, the computing device 2000 may fetch the user identification information (for example, serial information) from the authentication device 100.

The data storing controller 190 detects the login request message which is transmitted from the computing device 2000 to the application server 4000.

The data storing controller 190 detects the login request message to start the login request operation to the application server 4000. A packet which is transmitted from the computing device 2000 to the application server 4000 is transmitted to the application server 4000 through a communication interface of the authentication device 100. Therefore, the data storing controller 190 may confirm that the message is transmitted to the application server 4000 which is a fingerprint login site and that the message is a login request, based on the information (for example, a host of a HTTP protocol, a destination address, or URL) included in the login request message.

In the login request operation, the data storing controller 190 parses the identifier included in the login request message to store the identifier. The data storing controller 190 activates a sensor of the biometric information detector 110 and receives the fingerprint information of the user from the biometric information detector 110 to authenticate the fingerprint. There may be various fingerprint authentication methods. For example, the data storing controller 190 compares the received fingerprint information with the fingerprint information stored in the storage 170 to authenticate the fingerprint. In this case, the computing device 2000 displays a fingerprint check request screen to guide the user to input the fingerprint using the biometric information detector 110.

The data storing controller 190 transfers the login authentication information including a fingerprint authentication result for the parsed identifier to the control server 3000. In this case, the data storing controller 190 signs (encrypts) the login authentication information with the private key and transmits the encrypted login authentication information to the control server 3000. The login authentication information may include the identifier, the fingerprint authentication result (for example, 0 or 1), and the user identification information. The user identification information may be various information for identifying the user, such as the identification information (serial information) of the authentication device, the user's ID and password, or the phone number associated with the user. The user identification information may be transmitted from the computing device 2000. The authentication device 100 already knows the user identification information to be stored in. The user identification information is shared by the authentication device 100, the control server 3000, the application server 4000, and the data storage 5000. Hereinafter, it will be described that the authentication device 100 recognizes the user identification information and transmits the authentication information, which will be transmitted to the control server 3000, including the user identification information. Particularly, the user identification information may be the identification information (serial information) of the authentication device and may be registered in the control server 3000 at the time of registering the authentication device 100. Further, it is assumed that the application server 4000 and the data storage 5000 also know the registered user identification information and store user data by mapping to the user identification information. The application server 4000 and the data storage 5000 may register the user identification information using various methods.

The control server 3000 determines whether login is permitted based on the information included in the login authentication information. When the user identification information in the login authentication information is registered and the fingerprint authentication result is successful, the control server 3000 requests a login permission for the identifier included in the login authentication information, to the application server 4000. The control server 3000 transmits the user identification information, the fingerprint authentication result information, and a login permission identifier to the application server 4000. In this case, the control server 3000 decodes the login authentication information, which is signed (encrypted) with the private key, with the public key and determines whether the received login authentication information is authentic, based on the decoding result. When the login authentication information is trusted information (is authentic), the control server 3000 determines whether the login is permitted, based on information included in the login authentication information.

The application server 4000 permits the login of the login permitted identifier received from the control server 3000. That is, when the computing device 2000 accesses the application server 4000 with the login permitted identifier, the login of the computing device 2000 having the login permitted identifier is permitted.

The application server 4000 may assign an authority for every request service. Therefore, when the application server 4000 receives a directory information request from the login-permitted computing device 2000, the application server 4000 can respond to the request (provide directory information, etc.) without any additional authentication procedure. The request for additional authentication is set according to a policy. It is assumed that the additional authentication procedure is performed at the time of uploading and downloading the data.

Next, a method of uploading data to the application server 4000, by the user, after a login, will be described according to an exemplary embodiment.

The data storing controller 190 receives an upload request message, which is transmitted from the computing device 2000 to the application server 4000. The data storing controller 190 detects the upload request message to start an upload operation, transmitted to the application server 4000. The data storing controller 190 parses the identifier in the upload request message to store the identifier. The data storing controller 190 activates the sensor of the biometric information detector 110 and receives the user's fingerprint information from the biometric information detector 110 to authenticate the fingerprint. In this case, the computing device 2000 displays a fingerprint check request screen to guide the user to input the fingerprint using the biometric information detector 110.

After authenticating the fingerprint, the data storing controller 190 requests a data encryption key used for data encryption from the encryption key generator 150. For example, the data encryption key may be 32 byte key generated by the AES algorithm.

The data storing controller 190 transmits the upload authentication information including the fingerprint authentication result for the data encryption key and the identifier to the control server 3000. In this case, the data storing controller 190 signs (encrypts) the upload authentication information with the private key to transfer the upload authentication information to the control server 3000. The upload authentication information may include the identifier, the fingerprint authentication result (for example, 0 or 1), the user identification information, and the data encryption key.

The control server 3000 determines whether upload is permitted based on the information included in the upload authentication information. In this case, the control server 3000 decodes the upload authentication information, which is signed (encrypted) with the private key, using the public key and determines whether the received upload authentication information is authentic, based on the decoding result. When the upload authentication information is trusted information (authentic), the control server 3000 determines whether the upload is permitted, based on the information in the upload authentication information.

When the user identification information included in the upload authentication information is registered and the fingerprint authentication result is successful, the control server 3000 requests upload permission for the identifier in the upload authentication information, to the application server 4000. In this case, the control server 3000 may transmit the user identification information, the fingerprint authentication result, an upload-permitted identifier, and the data encryption key to the application server 4000.

The application server 4000 permits the upload of the upload permitted identifier received from the control server 3000. That is, when the computing device 2000 accesses the application server 4000 using the upload permitted identifier, the upload of the computing device 2000 having the upload permitted identifier is permitted. In this case, the application server 4000 checks whether the user identification information in the upload permission is registered. When the user identification information is the registered user identification information, the application server 4000 permits the upload permitted identifier to upload data.

The application server 4000 receives the upload data from the computing device 2000. When the upload data is transmitted from the authentication device 100 to the application server 4000, the upload data is transmitted to an encrypted communication line (channel or session) between the authentication device 100 and the application server 4000. Therefore, security of upload/download data is maintained by the communication line encryption.

The application server 4000 encrypts the upload data based on a data encryption key corresponding to the upload permitted identifier. Further, the application server 4000 stores the encrypted data in the data storage 5000 corresponding to the user identification information. In this case, the application server 4000 does not store the data encryption key. That is, the data encryption key temporarily exists in a memory of the application server 4000 and then the data encryption key in the memory encrypts the data at the moment when the application server 4000 decodes the upload data transmitted to the encrypted communication line. The data encryption key temporarily existing in the memory is not stored, but disappears.

Next, a method of downloading the data from the application server 4000, by the user, after login will be described according to an exemplary embodiment.

The data storing controller 190 receives a download request message which is transmitted from the computing device 2000 to the application server 4000. The data storing controller 190 detects the download request message to start the download request to the application server 4000. The data storing controller 190 parses an identifier in the download request message to store the identifier. The data storing controller 190 activates the sensor of the biometric information detector 110 and receives fingerprint information of the user from the biometric information detector 110 to authenticate the fingerprint of the user. In this case, the computing device 2000 displays a fingerprint check request screen to guide the user to input the fingerprint using the biometric information detector 110.

The data storing controller 190 requests the data decoding key used for data decoding, to the encryption key generator 150. When a symmetric key is used, the data decoding key is the same as the data encryption key. In this case, the data storing controller 190 stores the data encryption key used for data upload and fetches and uses the data encryption key which is stored after authenticating the fingerprint.

According to an exemplary embodiment, when the application server 4000 is responsible for the data decoding, the data storing controller 190 transfers download authentication information including the data encryption key and a fingerprint authentication result for the identifier to the control server 3000. In this case, the data storing controller 190 may sign (encrypt) the download authentication information with the private key to transfer the download authentication information to the control server 3000. The download authentication information may include the identifier, the fingerprint authentication result (for example, 0 or 1), the user identification information, and the data encryption key.

According to another exemplary embodiment, when the authentication device 100 is responsible for the data decoding, the data storing controller 190 may transfer the download authentication information including the identifier, the fingerprint authentication result (for example, 0 or 1), and the user identification information to the control server 3000 without transmitting the data encryption key. The data storing controller 190 may further include a data decoder.

The control server 3000 determines whether the download is permitted, based on the information in the download authentication information. In this case, the control server 3000 decodes the download authentication information, which is signed (encrypted) with the private key, using the public key and determines whether the received download authentication information is authentic, based on the decoding result. When the download authentication information is trusted information (authentic), the control server 3000 determines whether upload is permitted, based on information in the download authentication information.

When the user identification information in the download authentication information is registered and the fingerprint authentication result is successful, the control server 3000 requests download permission for the identifier in the download authentication information, to the application server 4000. In this case, the control server 3000 may transmit the user identification information, the fingerprint authentication result, a download-permitted identifier, and the data encryption key to the application server 4000.

The application server 4000 permits the download of the download permitted identifier, received from the control server 3000. That is, when the computing device 2000 accesses the application server 4000 with the download permitted identifier, the download of the computing device 2000 having the download permitted identifier is permitted. In this case, the application server 4000 checks whether the user identification information in the download permission is registered. When the user identification information is the registered user identification information, the application server 4000 permits the download permitted identifier to download data.

For the download, the application server 4000 fetches data stored corresponding to the user identification information, from the storage 5000. The data is encrypted with the data encryption key and the application server 4000 may decode the encrypted data based on the data encryption key received from the control server 3000. The application server 4000 transmits the decoded data to the authentication device 100 connected to the computing device 2000. The authentication device 100 transfers the received data to the computing device 2000. In this case, the application server 4000 does not store the data encryption key. That is, the data encryption key temporarily exists in the memory of the application server 4000 and then disappears without being stored after the encrypted data is decoded with the data encryption key by the application server 4000. In this case, the data decoded with the data encryption key is encrypted and transmitted through the encrypted communication line.

In the meantime, the application server 4000 may not receive the data encryption key from the control server 3000. In this case, the application server 4000 transmits the encrypted data to the authentication device 100 connected to the computing device 2000. By doing this, the data storing controller 190 of the authentication device 100 requests a data decoding key used for data decoding from the encryption key generator 150. When a symmetric key is used, the data decoding key is the same as the data encryption key. In this case, the data storing controller 190 stores the data encryption key used for data upload and fetches and uses the data encryption key which is stored after authenticating the fingerprint. Next, the authentication device 100 transfers the decoded data to the computing device 2000. A transmission line between the application server 4000 and the computing device 2000 uses various communication channel encryption technology. Data transmitted through the transmission line is protected by the communication channel encryption technology.

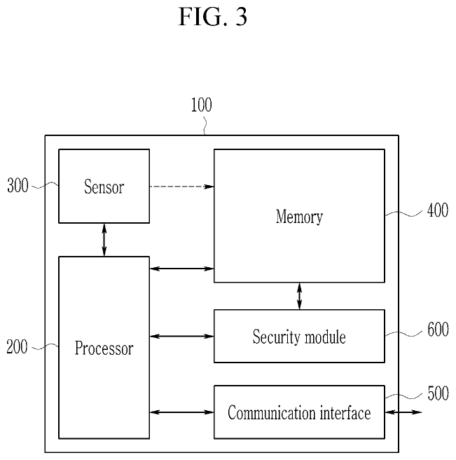

FIG. 3 is a block diagram illustrating hardware configuration of an authentication device according to an exemplary embodiment.

Referring to FIG. 3, there may be various hardware configurations of the authentication device 100 depending on designs. As illustrated in FIG. 3, the authentication device 100 may include a processor (CPU) 200, at least one sensor 300, at least one memory 400, at least one communication interface 500, and a security module 600.

The sensor 300 is a hardware which performs a function of the biometric information detector 110. When the authentication uses the fingerprint as biometric information, the sensor 300 may be a fingerprint sensor.

The memory 400 is a hardware which stores various information required for the operation of the processor 200. The memory 400 may store an operating system (OS) for driving the processor 200 and a program for various operations of the authentication device 100 described in an exemplary embodiment. The memory 400 may perform at least a part of the function of the storage 170. It should be understood that the memory may be separately implemented according to data to be stored. That is, the memory 400 may store the fingerprint information, the list of fingerprint login sites, a parsed identifier, and a user identification number. The information stored in the memory 400 may be updated or deleted after a predetermined period of time.

The communication interface 500 is hardware for physical connection with external devices. As described with reference to FIG. 2, the communication interface 500 may include a communication interface for connection with the computing device 2000 and a wired/wireless communication interface for communication network connection.

The security module 600 is hardware which performs a function of the encryption key generator 150.

The processor 200 communicates with the sensor 300, the memory 400, the communication interface 500, and the security module 600 and controls them. The processor 200 loads a program (for example, a program implementing an authentication information registration algorithm including a key generating algorithm and a program for storing data) stored in the memory 400 to perform the functions of the authentication key generator 130 and the data storing controller 190.

When the processor 200 is requested to register authentication information (also it will be described to issue a certificate or generate a public key and a private key), the processor 200 loads a program relating to the authentication information registration. The processor 200 generates the public key and the private key according to the key generating algorithm. The processor 200 transmits the public key to a certificate authority through the communication interface 500. Further, the processor 200 stores the private key. In this case, the processor 200 transmits the private key to the security module 600 so that the security module 600 may encrypt the private key and stores the encrypted private key in a designated location (for example, inside the security module 600).

There may be various key generating algorithms such as an algorithm of generating a public key and a private key based on random numbers, an algorithm of generating a public key and a private key including biometric (fingerprint) information, or an algorithm of generating a public key and a private key including biometric information and additional identification information.

The processor 200 detects a packet which is input and/or output to and/or from the computing device 2000. If the processor 200 detects a login request message, an upload request message, or a download request message, which is transmitted from the computing device 2000 to the application server 4000, the processor recognizes a start of a login authentication procedure, an upload authentication procedure, or a download authentication procedure. If so, the processor 200 loads the corresponding program, activates the sensor 300, and then operates in accordance with the program.

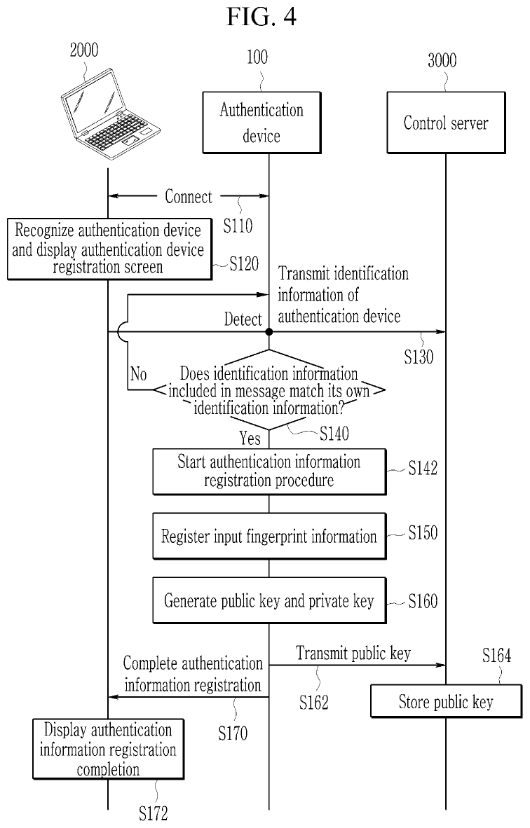

FIG. 4 is a flow diagram illustrating an authentication information registering method of an authentication device according to an exemplary embodiment. Here, the authentication information registering method is a method that generates a public key and a private key and registers the public key in the control server 3000 after storing the fingerprint, and is an initial setting operation.

Referring to FIG. 4, the authentication device 100 is connected to the computing device 2000 in operation S110.

The computing device 2000 recognizes the authentication device 100 and displays an authentication information registration screen in operation S120. The computing device 2000 drives a program related to the authentication device 100 and supports the authentication information registration procedure while communicating with the authentication device 100. The computing device 2000 is a device which supports communication between the authentication device 100 and the user and drives a program related to the authentication device 100 to provide a user interface screen. That is, the computing device 2000 may provide guidance (for example, a fingerprint input request to the authentication device 100) necessary for the authentication information registration procedure, to the user through the display screen. Particularly, in order to register the authentication device 100, the authentication information registration screen may request to input identification information of the authentication device 100, for example, serial information.

The computing device 2000 receives the identification information of the authentication device 100 and transmits a message including the identification information of the authentication device 100 to the control server 3000 in operation S130. For example, the identification information of the authentication device 100 may be serial information. Further, the identification information of the authentication device 100 may be user identification information.

The authentication device 100 detects a message including identification information of the authentication device 100 to compare the identification information included in the message with its own identification information in operation S140.

When the identification information matches each other, the authentication device 100 recognizes the authentication information registration procedure and starts the authentication information registration procedure in operation S142. The authentication device 100 may activate the sensor.

The authentication device 100 receives user's fingerprint information and registers (stores) the received fingerprint information in operation S150. The authentication device 100 may receive the user's fingerprint information several times. When the fingerprint information is successfully received, a notification about the successful fingerprint input may be output through an alarm device (for example, an LED or a speaker) of the authentication device 100 or the notification of the successful fingerprint input may be displayed on the authentication device registration screen of the computing device 2000.

The authentication device 100 generates the public key and the private key after registering the fingerprint in operation S160. The authentication device 100 generates the public key and the private key based on the key generating algorithm. The key generating algorithm may be an RSA key generating algorithm. Even though the authentication device 100 may use a prime number P and a prime number Q including the fingerprint information as an input of the RSA key generating algorithm, the authentication device 100 may generate the public key and the private key in accordance with a normal RSA key generating algorithm.

The authentication device 100 transmits the public key to the control server 3000 in operation S162. The authentication device 100 stores the private key. The authentication device 100 encrypts and stores the private key. The authentication device 100 encrypts the private key with an AES algorithm of the HSM to store the private key in the HSM.

The control server 3000 stores the public key in operation S164. In this case, the control server 3000 may store the public key by mapping the public key with the identification information of the authentication device 100.

The authentication device 100 transmits an authentication information registration completion message to the computing device 2000 in operation S170.

The computing device 2000 displays that the authentication information registration is completed on the authentication information registration screen in operation S172.

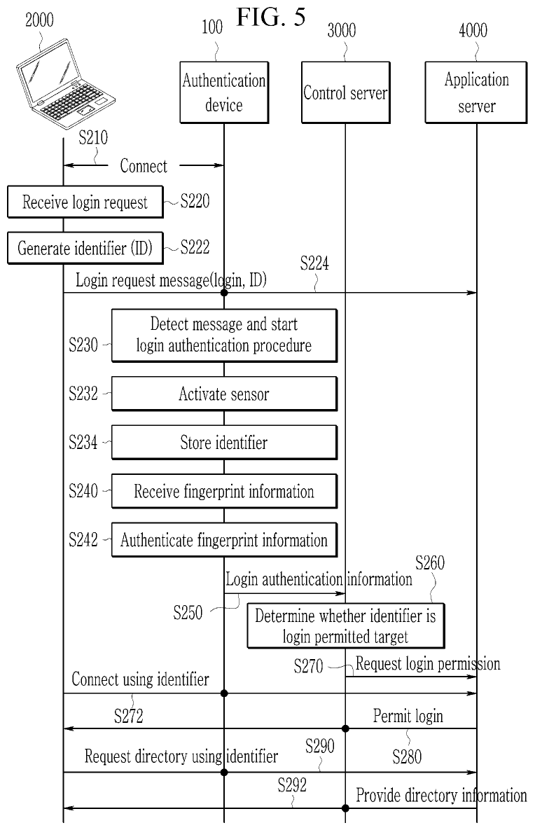

FIG. 5 is a flow diagram illustrating a login method according to an exemplary embodiment.

Referring to FIG. 5, the authentication device 100 and the computing device 2000 are connected to each other in operation S210.

The computing device 2000 receives a login request from the user to the application server 4000 in operation S220. The computing device 2000 may display a login request button on the login screen.

The computing device 2000 may generate an identifier in operation S222. The identifier may be randomly generated, for example, may be generated based on time information and an IP address of the computing device 2000. The identifier is used to specify an authentication target in the authentication device 100, the control server 3000, and the application server 4000. Here, a message including the identifier is considered as a message transmitted from the computing device 2000 so that the identifier may be an identifier of the computing device.

The computing device 2000 transmits a login request message including an identifier (ID) to the application server 4000 in operation S224. For example, the login request message (http://URL/login/?ID) may include URL of the application server 4000, information (login) indicating a login request, and an identifier (ID).

The authentication device 100 detects the login request message to start the login authentication procedure in operation S230.

The authentication device 100 activates the sensor in operation S232.

The authentication device 100 parses the identifier from the login request message to store the identifier in operation S234.

The authentication device 100 receives user's fingerprint information in operation S240.

The authentication device 100 authenticates the received fingerprint information in operation S242. The authentication device 100 compares the received fingerprint information with the stored fingerprint information to authenticate the received fingerprint.

The authentication device 100 transfers the login authentication information including a fingerprint authentication result for the identifier to the control server 3000 in operation S250. In this case, the authentication device 100 signs (encrypts) the login authentication information with the private key to transmit the login authentication information to the control server 3000. The login authentication information may include an identifier, a fingerprint authentication result (for example, 0 or 1), and user identification information. When the user identification information is in a message transmitted from the computing device 2000, as the login request message, the authentication device 100 parses the user identification information from the message transmitted from the computing device 2000. However, it is assumed that the authentication device 100 knows the user identification information.

The control server 3000 determines whether the login is permitted based on the information in the login authentication information in operation S260. When the user identification information in the login authentication information is registered and the fingerprint authentication result is successful, the control server 3000 determines the identifier in the login authentication information as a login permitted identifier. In this case, the control server 3000 verifies the login authentication information signed (encrypted) with the private key by the public key and determines whether the login is permitted based on the verified login authentication information.

The control server 3000 requests the login permission for an identifier in the login authentication information, to the application server 400 in operation S270. The control server 3000 may transmit the user identification information, the fingerprint authentication result information, and the login permitted identifier to the application server 4000.

The application server 4000 permits the login permitted identifier received from the control server 3000 to login in operation S280. When user identification information in the login permission request is registered, the application server 4000 stores the login permitted identifier and permits the login of the login permitted identifier.

The computing device 2000 requests directory information using the login permitted identifier to the application server 4000 in operation S290.

The application server 4000 searches user identification information corresponding to the login permitted identifier and provides directory information which matches the user identification information to the computing device 2000 in operation S292.

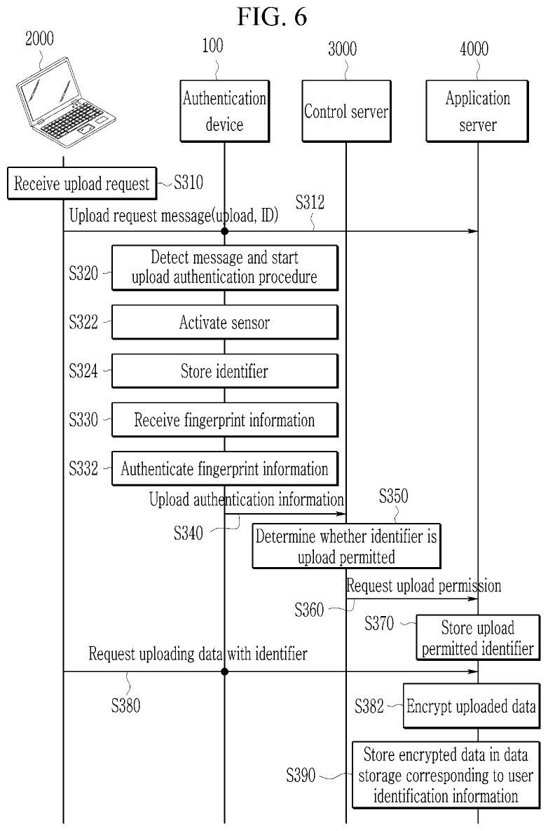

FIG. 6 is a flow diagram illustrating data uploading method according to an exemplary embodiment.

Referring to FIG. 6, the computing device 2000 may upload data after login to the application server 4000, according to an exemplary embodiment.

The computing device 2000 receives, from the user, a data upload request in which the user requests to upload data to the application server 4000, in operation S310. The computing device 2000 may display an upload request button and a screen for selecting a file to be uploaded. Particularly, the computing device 2000 requests the directory information from the application server 4000 and checks directory information matching the user identification information.

The computing device 2000 transmits an upload request message including an identifier to the application server 4000 in operation S312. For example, the upload request message (http://URL/upload/?ID) may include URL of the application server 4000, information (upload) indicating an upload request, and an identifier (ID). The identifier in the upload request message may be the same as or different from the identifier in the login request message.

The authentication device 100 detects the upload request message to start the upload authentication procedure in operation S320.

The authentication device 100 activates the sensor in operation S322.

The authentication device 100 parses the identifier from the upload request message to store the identifier in operation S324.

The authentication device 100 receives user's fingerprint information in operation S330.

The authentication device 100 authenticates the input fingerprint information in operation S332. The authentication device 100 compares the received fingerprint information with the stored fingerprint information to authenticate the received fingerprint.

The authentication device 100 transmits the upload authentication information including a fingerprint authentication result for the identifier to the control server 3000 in operation S340. In this case, the authentication device 100 signs (encrypts) the upload authentication information with the private key to transmit the upload authentication information to the control server 3000. The upload authentication information may include an identifier, a fingerprint authentication result (for example, 0 or 1), user identification information, and a data encryption key. The authentication device 100 transmits the data encryption key so as to encrypt and store the file uploaded by itself in the control server 3000. When the fingerprint authentication result is successful, the authentication device 100 fetches the data encryption key which is stored at the time of registering the authentication.

The control server 3000 determines whether upload is permitted based on information in the upload authentication information in operation S350. When the user identification information in the upload authentication information is registered and the fingerprint authentication result is successful, the control server 3000 determines the identifier in the upload authentication information as an upload permitted identifier.

The control server 3000 requests upload permission for the identifier in the upload authentication information, to the application server 4000 in operation S360. The control server 3000 may transmit the identifier, the fingerprint authentication result (for example, 0 or 1), user identification information and data encryption key to the application server 4000. In this case, the control server 3000 verifies the upload authentication information which is signed (encrypted) with the private key, with the public key and determines whether the upload is permitted based on the verified upload authentication information.

The application server 4000 stores the upload permitted identifier received from the control server 3000 in operation S370.

The application server 4000 receives a request of uploading data with the upload permitted identifier from the computing device 2000 in operation S380. In this case, the data may be uploaded through a separate socket. The uploaded data is encrypted by communication channel encryption technology and transmitted.

The application server 4000 encrypts the uploaded data with a data encryption key corresponding to the upload permitted identifier in operation S382. In this case, the application server 4000 encrypts the received data in packet basis. That is, every packet reaching the application server 4000 in the upload data is individually encrypted to be stored. Therefore, the security may be enhanced as compared with the related art in which the entire packets in data is encrypted once.

The application server 4000 stores the encrypted data in a data storage corresponding to the user identification information in operation S390. In this case, the application server 4000 does not store data encryption key.

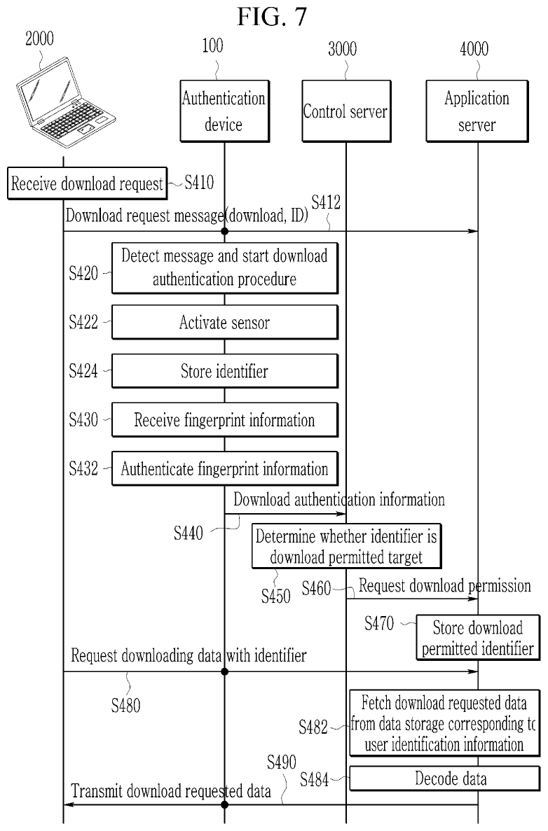

FIG. 7 is a flow diagram illustrating a data downloading method, according to an exemplary embodiment.

Referring to FIG. 7, the computing device 2000 may download the data after logging in the application server 4000. An exemplary embodiment in which the application server 4000 decodes the download requested data to transmit the data to the authentication device 100 will be described.

The computing device 2000 receives a data download request from the user, to be transmitted to the application server 400, in operation S410. The computing device 2000 may display a download request button and a screen for selecting a file to be downloaded. Particularly, the computing device 2000 requests the directory information from the application server 4000 and checks directory information matching the user identification information.

The computing device 2000 transmits a download request message including an identifier to the application server 4000 in operation S412. For example, the download request message (http://URL/download/?ID) may include URL of the application server 4000, information (download) indicating a download request, and an identifier (ID). The identifier in the download request message may be the same as or different from the identifier in the login request message or the upload request message.

The authentication device 100 detects the download request message to start the download authentication procedure in operation S420.

The authentication device 100 activates the sensor in operation S422.

The authentication device 100 parses the identifier from the download request message to store the identifier in operation S424.

The authentication device 100 receives user's fingerprint information in operation S430.

The authentication device 100 authenticates the input fingerprint information in operation S432. The authentication device 100 compares the received fingerprint information with the stored fingerprint information to authenticate the received fingerprint.

The authentication device 100 transmits the download authentication information including a fingerprint authentication result for the identifier to the control server 3000 in operation S440. In this case, the authentication device 100 signs (encrypts) the download authentication information with the private key to transmit the download authentication information to the control server 3000. The download authentication information may include an identifier, a fingerprint authentication result (for example, 0 or 1), user identification information, and a data encryption key. The authentication device 100 transmits a data encryption key which may decode the file encrypted in the control server 3000. When the fingerprint authentication result is successful, the authentication device 100 fetches the data encryption key which is stored at the time of registering the authentication.

The control server 3000 determines whether download is permitted based on information in the download authentication information in operation S450. When the user identification information in the download authentication information is registered and the fingerprint authentication result is successful, the control server 3000 determines the identifier in the download authentication information as a download permitted identifier or target.

The control server 3000 requests download permission for the identifier in the download authentication information to the application server 4000 in operation S460. The control server 3000 may transmit the identifier, the fingerprint authentication result (for example, 0 or 1), user identification information, and data encryption key to the application server 4000.

The application server 4000 stores the download permitted identifier received from the control server 3000 in operation S470.

The application server 4000 receives a request of downloading data with the download permitted identifier from the computing device 2000 in operation S480. The download request includes information which may specify data like a file name stored in the directory information provided from the application server 4000.

The application server 4000 fetches data which is requested to be download from the data storage in operation S482. The application server 4000 checks the user identification information corresponding to the download permitted identifier and fetches download requested data from the data storage corresponding to the user identification information.

The application server 4000 decodes the download requested data with the data encryption key corresponding to the download permitted identifier in operation S484.

The application server 4000 transmits the download requested data to the computing device 2000 in operation S490. The download requested data is transmitted to the computing device 2000 via the authentication device 100. In this case, the application server 4000 does not store the data encryption key. In this case, the data may be transmitted through a separate socket. The downloaded data is encrypted by communication channel encryption technology and transmitted.

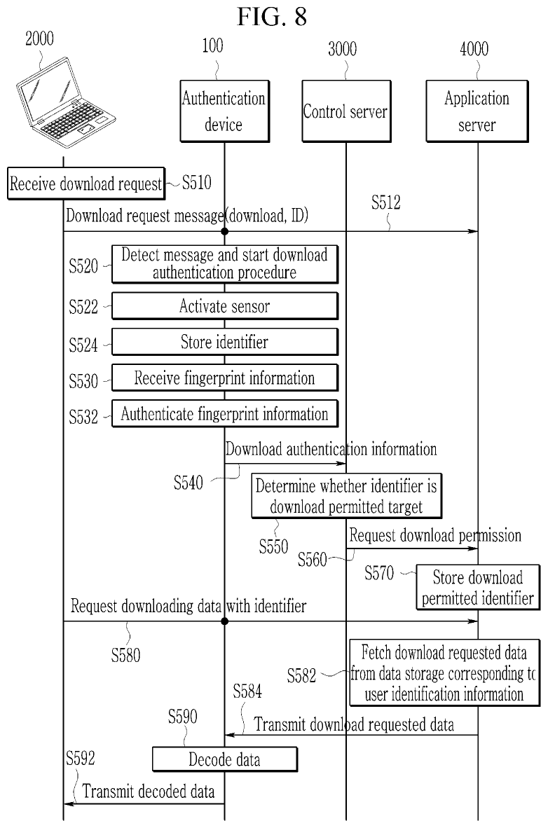

FIG. 8 is a flow diagram illustrating a data downloading method, according to another exemplary embodiment.

Referring to FIG. 8, the computing device 2000 may download the data after logging in the application server 4000. Here, an exemplary embodiment in which when the application server 4000 transmits the encrypted data to the authentication device 100, the authentication device 100 decodes the encrypted data to transmit the encrypted data to the computing device 2000 will be described.

The computing device 2000 receives, from a user, a data download request for the application server 4000, in operation S510. The computing device 2000 may display a download request button and a screen for selecting a file to be downloaded. Particularly, the computing device 2000 requests the directory information to the application server 4000 and checks directory information matching the user identification information.

The computing device 2000 transmits a download request message including an identifier to the application server 4000, in operation S512. For example, the download request message (http://URL/download/?ID) may include URL of the application server 4000, information (download) indicating a download request, and an identifier (ID). The identifier in the download request message may be the same as or different from the identifier in the login request message or the upload request message.

The authentication device 100 detects the download request message to start the download authentication procedure, in operation S520.

The authentication device 100 activates the sensor in operation S522.

The authentication device 100 parses the identifier from the download request message to store the identifier in operation S524.

The authentication device 100 receives user's fingerprint information in operation S530.

The authentication device 100 authenticates the input fingerprint information in operation S532. The authentication device 100 compares the received fingerprint information with the stored fingerprint information to authenticate the received fingerprint.

The authentication device 100 transmits the download authentication information including a fingerprint authentication result for the identifier to the control server 3000 in operation S540. In this case, the authentication device 100 signs (encrypts) the download authentication information with the private key to transmit the download authentication information to the control server 3000. The download authentication information may include an identifier, a fingerprint authentication result (for example, 0 or 1), and user identification information. In this case, since the authentication device 100 decodes the data, the data encryption key stored at the time of authentication registration may not be transmitted to the control server 3000.

The control server 3000 determines whether download is permitted based on information in the download authentication information in operation S550. When the user identification information in the download authentication information is registered and the fingerprint authentication result is successful, the control server 3000 determines the identifier in the download authentication information as a download permitted identifier.

The control server 3000 requests download permission for the identifier in the download authentication information to the application server 4000 in operation S560. The control server 3000 may transmit the identifier, the fingerprint authentication result (for example, 0 or 1), and user identification information to the application server 4000.

The application server 4000 stores the download permitted identifier received from the control server 3000 in operation S570.

The application server 4000 receives a request of downloading data with the download permitted identifier from the computing device 2000 in operation S580. The download request includes information which may specify data like a file name stored in the directory information provided from the application server 4000.

The application server 4000 fetches data which is requested to be downloaded from the data storage in operation S582. The application server 4000 checks the user identification information corresponding to the download permitted identifier and fetches download requested data from the data storage corresponding to the user identification information.

The application server 4000 transmits the download requested data to the authentication device 100 connected to the computing device 2000 in operation S584. In this case, the data is transmitted in an encrypted state. The data may be transmitted through a separate socket. The downloaded data is encrypted by communication channel encryption technology and transmitted.

The authentication device 100 decodes the received data using the data encryption key stored at the time of authentication registration in operation S590.

The authentication device 100 transmits the decoded data to the computing device 2000 in operation S592.

As described above, according to exemplary embodiments, since the application server encrypts and stores the data, even though the encrypted data may be exposed, the encrypted data cannot be decoded by the other party. According to exemplary embodiments, the application server encrypts and decodes the data using an encryption key which temporarily exists when the data is uploaded/downloaded, so that the encryption key is not stored in any of network devices. Accordingly, according to exemplary embodiments, security may be enhanced. Further, according to exemplary embodiment, since a communication line between the authentication device and the application server is encrypted, data transmitted to the application server is encrypted by communication channel encryption technology and the encryption key is protected. Therefore, the security of the data in all transmission sessions and storage locations is very high.

Exemplary embodiments described above is not implemented only by the method and the apparatus, but may be implemented by a program which implements a function corresponding to a configuration of exemplary embodiment or a recording medium in which the program is recorded.

While exemplary embodiments have been described, it is to be understood that the present disclosure is not limited to the disclosed exemplary embodiments, but, on the contrary, is intended to cover various modifications and equivalent arrangements included within the spirit and scope of the appended claims and their equivalents.

1. A method of processing login to an application server requested from a computing device, by a biometric information based authentication device which is connected to the computing device and interworks with a control server, the method comprising:
detecting a login request message which is transmitted from the computing device to the application server;
extracting an identifier included in the login request message;
outputting a biometric information authentication result for input biometric information; and
transmitting login authentication information comprising the identifier and the biometric information authentication result to the control server,
wherein the identifier is transmitted from the control server to the application server to determine, by the application server, a login permitted target, and
wherein the biometric information authentication result is to determine, by the control server, whether the login to the application server is permitted.

2. The login method of claim 1, wherein the login authentication information further comprises user identification information, and
wherein the user identification information is to determine whether the user is a registered user by at least one of the control server and the application server.

3. The login method of claim 1, wherein the identifier is randomly generated by the computing device.

4. A method of uploading and downloading data to an application server requested from a computing device, by a biometric information based authentication device which is connected to the computing device and interworks with a control server, the method comprising:
detecting an upload request message which is transmitted from the computing device to the application server;
extracting a first identifier included in the upload request message;
outputting a first biometric information authentication result for first biometric information received; and
transmitting upload authentication information comprising the first identifier, the first biometric information authentication result, and a first data encryption key to the control server,
wherein the first identifier is transmitted from the control server to the application server to determine, by an application server, an upload permitted target,
wherein the first biometric information authentication result is to determine, by the control server, whether the upload is permitted, and
wherein the first data encryption key is transmitted from the control server to the application server to encrypt, by the application server, the requested data of the upload.

5. The data upload and download method of claim 4, wherein the upload authentication information further comprises user identification information, and
wherein the user identification information is to determine whether the user is a registered user by at least one of the control server and the application server.

6. The data upload and download method of claim 4, further comprising:
fetching the first data encryption key when the first biometric information authentication result is successful.

7. The data upload and download method of claim 4, further comprising:
detecting a download request message which is transmitted from the computing device to the application server;
extracting a second identifier included in the download request message;
outputting a second biometric information authentication result for second biometric information received;
transmitting download authentication information comprising the second identifier, the second biometric information authentication result, and a second data encryption key to the control server;
receiving download data related to the download request message from the application server; and
transmitting the download data to the computing device,
wherein the second identifier is transmitted from the control server to the application server to determine, by the application server, a download permitted target in the application server,
wherein the second biometric information authentication result is to determine, by the control server, whether the download is permitted, and,
wherein the second data encryption key is transmitted from the control server to the application server to decode, by the application server, the download requested data.

8. The data upload and download method of claim 4, further comprising:
detecting a download request message which is transmitted from the computing device to the application server;
extracting a second identifier included in the download request message;
outputting a second biometric information authentication result for second biometric information received;
transmitting download authentication information comprising the second identifier and the second biometric information authentication result to the control server;
receiving download data related to the download request message from the application server; and
decoding the download data with a second data encryption key related to the first data encryption key to transmit the decoded download data to the computing device,
wherein the second identifier is transmitted from the control server to the application server to determine, by the application server, a download permitted target, and
wherein the second biometric information authentication result is to determine, by the control server, whether the download is permitted.

9. A method of processing a procedure requested from a computing device, by a control server which interworks with a biometric information based authentication device and an application server, the method comprising:
receiving upload authentication information comprising a first identifier, a first biometric information authentication result, and a first data encryption key from the authentication device;
determining the first identifier as an upload permitted target based on the upload authentication information; and
transmitting an upload permission request message comprising the first identifier and the first data encryption key to the application server,
wherein the first identifier is to determine, by the application server, an upload permitted target, and
wherein the first data encryption key is to encrypt, by the application server, upload requested data.

10. The processing method of claim 9, further comprising:
receiving, from the authentication device, download authentication information comprising a second identifier and a second biometric information authentication result;
determining the second identifier as a download permitted target based on the download authentication information; and
transmitting a download permission request message comprising the second identifier to the application server,
wherein the second identifier is to determine, by the application server, a download permitted target.

11. The method of claim 10, wherein the first identifier is determined as the upload permitted target when the upload authentication information further comprises user identification information, the user identification information is registered information and the first biometric information authentication result is successful, and
wherein the second identifier is determined as the download permitted target when the download authentication information further comprises the user identification information, the user identification information is registered information and the second biometric information authentication result is successful

12. A method of processing a procedure requested from a computing device, by an application server which interworks with a control server, the method comprising:
receiving an upload permission request message comprising a first identifier and a first data encryption key from the control server;
receiving an upload request message comprising a first identifier and upload requested data from the computing device; and
encrypting and storing the upload requested data using the first data encryption key corresponding to the first identifier,
wherein the first data encryption key is generated by a biometric information based authentication device and is transmitted to the control server from the authentication device.

13. The processing method of claim 12,
wherein the upload permission request message further comprises user identification information, and
wherein the encrypting and storing the upload requested data comprises, when the user identification information is registered information, encrypting the upload requested data and storing the encrypted data in a data storage corresponding to the user identification information.

14. The processing method of claim 12, further comprising:
receiving a download permission request message comprising a second identifier and a second data encryption key from the control server;
receiving a download request message comprising the second identifier and a download request for specific data from the computing device;
decoding the specific data using the second data encryption key corresponding to the second identifier; and
transmitting the decoded specific data to the computing device,
wherein the second data encryption key is generated by the authentication device and is transmitted to the control server from the authentication device.

15. The method of claim 14, wherein the encrypting and storing the upload requested data comprises, when the upload permission request message further comprises user identification information and the user identification information is registered information, encrypting the upload requested data and storing the encrypted data in a data storage corresponding to the user identification information, and
wherein the decoding the specific data comprises, when the download permission request message further comprises the user identification information and the user identification information is registered information, locating the specific data from the data storage corresponding to the user identification information and decoding the specific data with the second data encryption key.

16. The processing method of claim 12, further comprising:
receiving a download permission request message from the control server;
receiving a download request message comprising a second identifier and a download request for specific data from the computing device; and
transmitting the specific data corresponding to the second identifier to the; authentication device,
wherein the specific data is decoded by the authentication device.

17. A biometric information based authentication device, comprising:
at least one sensor which recognizes biometric information,
at least one communication interface which communicates with a plurality of external devices,
a memory which stores a program;
a security module which encrypts input data and outputs the encrypted data; and
a processor which interworks with the sensor, the communication interface, the memory, and the security module to execute a plurality of operations of the program,
wherein the program comprises a first program for data upload authentication,
wherein the first program comprises instructions for activating the sensor when an upload request message, transmitted from a computing device to an application server, is detected, generating upload authentication information after obtaining a first data encryption key from the security module, and transmitting the upload authentication information to a control server,
wherein the upload authentication information comprises a first identifier extracted from the upload request message, a first biometric information authentication result of first biometric information input from the sensor, and the first data encryption key,
wherein the first identifier is transmitted from the control server to the application server to determine, by the application server, an upload permitted target,
wherein the first biometric information authentication result is to determine, by the control server, whether the upload is permitted, and
wherein the first data encryption key is transmitted from the control server to the application server to encrypt, by in the application server, upload requested data.

18. The authentication device of claim 17,
wherein the program comprises a second program for data download authentication,
wherein the second program comprise instructions for activating the sensor when a download request message, transmitted from the computing device to the application server, is detected, generating download authentication information after obtaining a second data encryption key from the security module, and transmitting the download authentication information to the control server,
wherein the download authentication information comprises a second identifier extracted from the download request message and a second biometric information authentication result of second biometric information input from the sensor,
wherein the second identifier is transmitted from the control server to the application server to determine, by the application server, a download permitted target, and
wherein the second biometric information authentication result is to determine, by the control server, whether the download is permitted.

19. The authentication device of claim 17, wherein the second program further comprises instructions for
decoding the download data with a second data encryption key related to the first data encryption key, and
transmitting the download data to the computing device, in response to receiving the download data related to the download request message from the application server.

20. The authentication device of claim 17, wherein the program comprises a third program for login authentication,
wherein the third program comprises instructions for activating the sensor when a login request message, transmitted from the computing device to the application server, is detected, generating login authentication information, and transmitting the login authentication information to the control server,
wherein the login authentication information comprises a third identifier extracted from the login request message and a third biometric information authentication result of third biometric information input from the sensor,
wherein the third identifier is transmitted from the control server to the application server to determine, by the application server, a login permitted target, and
wherein the third biometric information authentication result is to determine, by the control server, whether the login is permitted.
